(19) United States
(12) Patent Application Publication
(10) Pub. No.: US 2008/0201436 A1
(43) Pub. Date: Aug. 21, 2008

(54) ENHANCED INFORMATION SYSTEM AND METHOD

(76) Inventor: GIDEON GARTNER, New York, NY (US)

Correspondence Address: HOLLAND & KNIGHT LLP, 10 ST. JAMES AVENUE, 11th Floor, BOSTON, MA, 02116-3889, US

(21) Appl. No.: 11/676,811

(22) Filed: Feb. 20, 2007

(51) Int. Cl. G06F 15/16; G06F 15/173

(52) U.S. Cl. 709/206; 709/224

(57) ABSTRACT

A method and computer program product for monitoring one or more actions taken by a user of a website. At least one of the one or more actions is associated with one or more experts skilled in a technological area associated with the one or more actions. Communication between the user and at least one of the one or more experts skilled in the technological area is facilitated.

### TECHNICAL FIELD

This disclosure relates to information processes and, more particularly, to web-based enhanced information processes.

### BACKGROUND

The internet is a wonderful tool for researching information concerning innumerable topics. Unfortunately, there is no guarantee that the information procured from the internet is accurate, unbiased and/or trustworthy. For example, biased information may be placed on the internet. Further and more serious, misleading/inaccurate information may be intentionally placed on the internet to deceive/mislead readers.

Accordingly, it may be desirable to obtain feedback/second opinions from other users concerning the information obtained from the internet. However, it is often difficult to obtain such feedback/second opinions.

Further, organizations may have no idea when, how often, and where their information technology (i.e., IT) professionals go on the internet for their IT information. Accordingly, it may be desirable for an organization to employ one or more systems that monitor, record, and analyze the web interactions of their IT professionals.

### SUMMARY OF THE DISCLOSURE

In a first implementation of this disclosure, a method includes monitoring one or more actions taken by a user of a website. At least one of the one or more actions is associated with one or more experts skilled in a technological area associated with the one or more actions. Communication between the user and at least one of the one or more experts skilled in the technological area is facilitated.

One or more of the following features may also be included. The at least one of the one or more actions may include the user reviewing a content item. Monitoring one or more actions taken by a user of a website may include identifying one or more specific portions of the content item being reviewed by the user. Associating at least one of the one or more actions may include associating at least one of the specific portions of the content item being reviewed by the user with one or more experts skilled in a technological area associated with the at least one of the specific portions of the content item being reviewed by the user.

Communication may be established between the user and the at least one of the one or more experts skilled in the technological area. A copy of at least a portion of the content being reviewed by the user may be transferred to the at least one of the one or more experts skilled in the technological area. The copy of the content transferred to the at least one of the one or more experts skilled in the technological area may be deleted once communication between the user and the at least one of the one or more experts skilled in the technological area is completed.

Establishing communication may include one or more of: initiating a video conference between the user and at least one of the one or more experts skilled in the technological area; initiating an audio conference between the user and at least one of the one or more experts skilled in the technological area; and initiating an email conference between the user and at least one of the one or more experts skilled in the technological area.

A grade may be assigned to a content item being reviewed by the user. A content item being reviewed by the user may be critiqued.

The one or more actions taken by the user may include browsing the website. A URL associated with the website may be identified. A query may be executed on a datastore based, at least in part, upon the URL associated with the website to identify available information that is associated with the website. At least a portion of the available information may be presented to the user. The one or more actions taken by the user may be recorded to define consumer information. Marketing information may be extracted from the consumer information.

In another implementation of this disclosure, a computer program product resides on a computer readable medium and has a plurality of instructions stored on it. When executed by a processor, the computer program product causes the processor to perform operations including monitoring one or more actions taken by a user of a website. At least one of the one or more actions is associated with one or more experts skilled in a technological area associated with the one or more actions. Communication between the user and at least one of the one or more experts skilled in the technological area is facilitated.

One or more of the following features may also be included. The at least one of the one or more actions may include the user reviewing a content item. Monitoring one or more actions taken by a user of a website may include identifying one or more specific portions of the content item being reviewed by the user. Associating at least one of the one or more actions may include associating at least one of the specific portions of the content item being reviewed by the user with one or more experts skilled in a technological area associated with the at least one of the specific portions of the content item being reviewed by the user.

Communication may be established between the user and the at least one of the one or more experts skilled in the technological area. A copy of at least a portion of the content being reviewed by the user may be transferred to the at least one of the one or more experts skilled in the technological area. The copy of the content transferred to the at least one of the one or more experts skilled in the technological area may be deleted once communication between the user and the at least one of the one or more experts skilled in the technological area is completed.

Establishing communication may include one or more of: initiating a video conference between the user and at least one of the one or more experts skilled in the technological area; initiating an audio conference between the user and at least one of the one or more experts skilled in the technological area; and initiating an email conference between the user and at least one of the one or more experts skilled in the technological area.

A grade may be assigned to a content item being reviewed by the user. A content item being reviewed by the user may be critiqued.

The one or more actions taken by the user may include browsing the website. A URL associated with the website may be identified. A query may be executed on a datastore based, at least in part, upon the URL associated with the website to identify available information that is associated with the website. At least a portion of the available information may be presented to the user. The one or more actions taken by the user may be recorded to define consumer information. Marketing information may be extracted from the consumer information.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an enhanced information process executed in whole or in part by a computer coupled to a distributed computing network;

FIG. 2 is a flowchart of the enhanced information process of FIG. 1;

FIG. 3 is a diagrammatic view of a screen rendered (in whole or in part) by the enhanced information process of FIG. 1; and

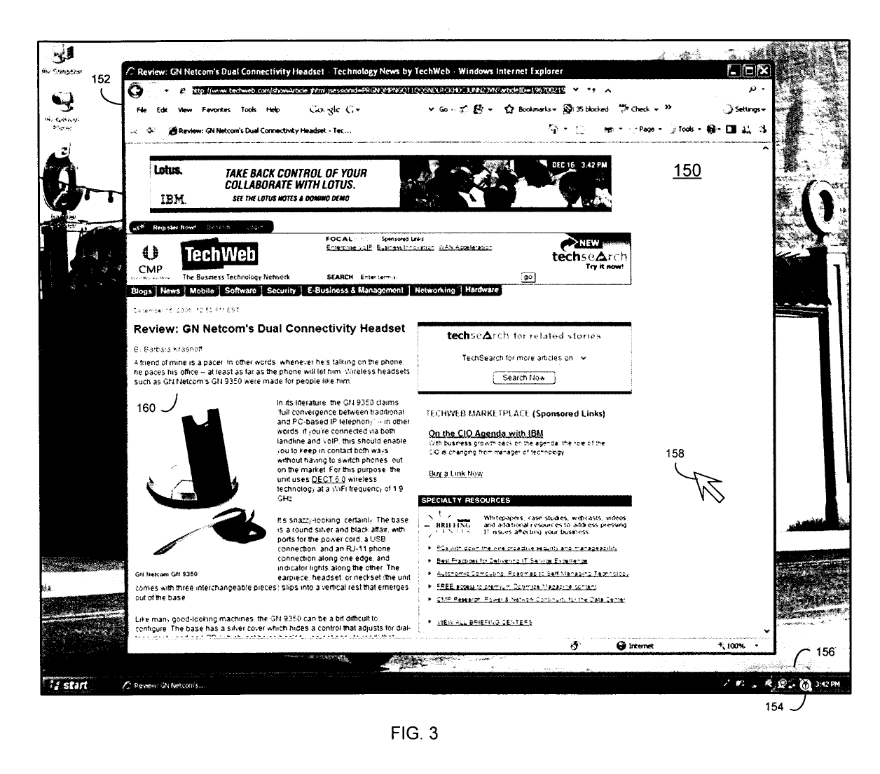

FIG. 4 is a diagrammatic view of a screen rendered (in whole or in part) by the enhanced information process of FIG. 1.

### DETAILED DESCRIPTION OF THE PREFERRED EMBODIMENTS

### Server-Side Process:

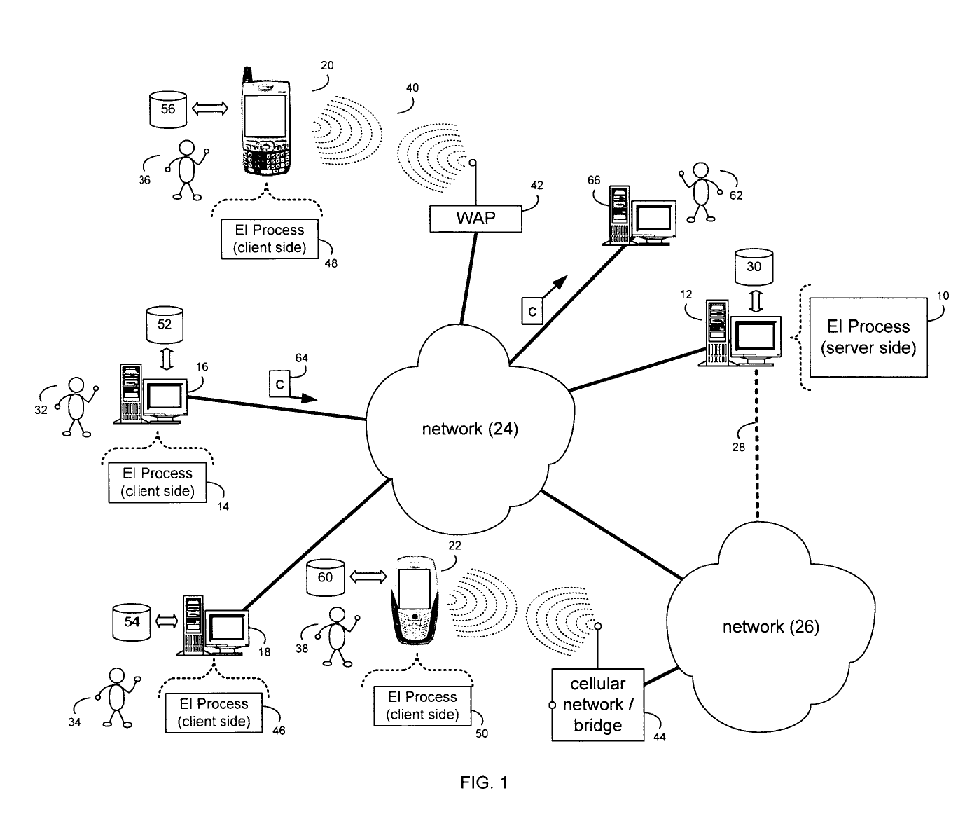

Referring to FIG. 1, there is shown an enhanced information (EI) process, which may include a server-side application (e.g., server-side EI process 10) resident on (in whole or in part) and executed by (in whole or in part) server computer 12 (e.g., a single server computer, a plurality of server computers, or a general purpose computer, for example). Additionally/alternatively, the enhanced information process may include a client-side application (e.g., client-side EI process 14) resident on (in whole or in part) and executed by (in whole of in part) a client computing device (e.g., client computer 16, client computer 18, personal digital assistant 20, data-enabled cellular telephone 22, laptop computers (not shown), notebook computers (not shown), cable boxes (not shown), televisions (not shown), gaming consoles (not shown), and dedicated network appliances (not shown), for example. As will be discussed below in greater detail, EI processes 10, 14 may make available, to visitors of a website, enhanced information concerning the content that the visitor of the website is reviewing.

Server computer 12 may be coupled to distributed computing network 24 (e.g., the Internet). Server computer 12 may be, for example, a web server running a network operating system, examples of which may include but are not limited to Microsoft Windows XP Server™, or Redhat Linux™.

Server computer 12 may also execute a web server application, examples of which may include but are not limited to Microsoft IIS™, or Apache Webserver™, that allows for HTTP (i.e., HyperText Transfer Protocol) access to server computer 12 via network 24. Network 24 may be coupled to one or more secondary networks (e.g., network 26), such as: a local area network; a wide area network; or an intranet, for example. Additionally/alternatively, server computer 12 may be coupled to network 24 through secondary network 26, as illustrated with phantom link line 28.

The instruction sets and subroutines of server-side EI process 10, which may be stored on a storage device 30 coupled to server computer 12, may be executed by one or more processors (not shown) and one or more memory architectures (not shown) incorporated into server computer 12. Storage device 30 may include, but is not limited to, a hard disk drive, a tape drive, an optical drive, a RAID array, a random access memory (RAM), or a read-only memory (ROM).

Users 32, 34, 36, 38 may access server-side EI process 10 (directly through network 24 or through secondary network 26) using various computing devices, examples of which may include but are not limited to: client computer 16, client computer 18, personal digital assistant 20, data-enabled cellular telephone 22, laptop computers (not shown), notebook computers (not shown), cable boxes (not shown), televisions (not shown), gaming consoles (not shown), and dedicated network appliances (not shown), for example.

The various computing devices may be directly or indirectly coupled to network 24 (or network 26). For example, client computers 16, 18 are shown directly coupled to network 24 via hardwired network connections. Further, personal digital assistant 20 is shown wirelessly coupled to network 24 via a wireless communication channel 40 established between personal digital assistant 20 and wireless access point (i.e., WAP) 42, which is shown directly coupled to network 24. Additionally, cellular telephone 22 is shown wirelessly coupled to cellular network/bridge 44, which is shown directly coupled to network 26.

WAP 42 may be, for example, an IEEE 802.11a, 802.11b, 802.11g, Wi-Fi, and/or Bluetooth device that is capable of establishing secure communication channel 40 between personal digital assistant 20 and WAP 42.

As is known in the art, all of the IEEE 802.11x specifications use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Client-Side Process:

Client computers 16, 18, personal digital assistant 20, and data-enabled cellular telephone 22 may each execute a client-side EI process (e.g., EI Processes 14, 46, 48, 50 respectively) that allows e.g., users 32, 34, 36, 38 to access server-side EI Process 10. Client-side EI Processes 14, 46, 48, 50 may be stand-alone applications or may be modules, applets, or plug-ins that operate within other applications. Examples of such other applications may include, but are not limited to, web browser applications such as Microsoft Internet Explorer™, Mozilla Firefox™, and Netscape Navigator™)

Client computers 16, 18, personal digital assistant 20, and data-enabled cellular telephone 22 may execute an operating system, examples of which may include but are not limited to Microsoft Windows XP™, Microsoft Windows Mobile™, and Redhat Linux™.

The instruction sets and subroutines of EI Processes 14, 46, 48, 50, which may be stored on a storage devices 52, 54, 56, 60 (respectively) coupled to client computers 16, 18, personal digital assistant 20, and data-enabled cellular telephone 22, may be executed by one or more processors (not shown) and one or more memory architectures (not shown) incorporated into client computers 16, 18, personal digital assistant 20, and data-enabled cellular telephone 22. Storage devices 52, 54, 56, 58 may include, but are not limited to, a hard disk drive, a tape drive, an optical drive, a RAID array, a random access memory (RAM), a read-only memory (ROM), a compact flash (CF) storage device, a secure digital (SD) storage device, and a memory stick storage device.

### EI Process Operation:

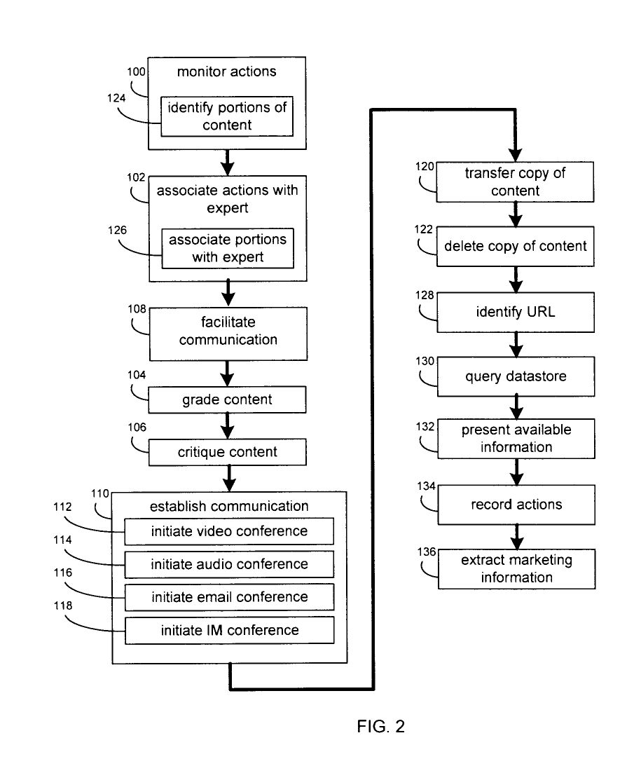

Referring also to FIGS. 2 & 3, server-side EI process 10, client-side EI process 14, 46, 48, 50, or a combination of server-side EI process 10 and client-side EI process 14, 46, 48, 50 may make available, to a visitor (e.g., users 32, 34, 36, 38) of a website (website 150), enhanced information concerning the content that the visitor of the website is reviewing. An example of the type of website that the user may be reviewing may include, but is not limited to, a information technology (i.e., IT) website that provides IT-related content (e.g., reviews and information) concerning various operating systems, applications, and hardware platforms, for example. Examples of such an IT-related website may include, but are not limited to: www.cnet.com; www.zdnet.com; and www.techweb.com.

As discussed above, client-side EI process 14, 46, 48, 50 may be stand-alone applications or may be modules, applets, or plug-ins that operate within other applications. For example, if a stand-alone application, client-side EI process 14, 46, 48, 50 may automatically load each time e.g., the computer, the operating system, or a specific application is started. Alternatively, if a module, applet or plug-in, client-side EI process 14, 46, 48, 50 may start upon another application being started. For example, if one or more of client-side EI processes 14, 46, 48, 50 is a module, applet or plug-in of web browsing application 152, client-side EI process 14, 46, 48, 50 may be automatically started upon web browsing application 152 being started. Regardless of whether a stand-alone application or a module, applet, or plug-in, an icon 154 may be rendered within e.g., system tray 156 to indicate that EI process 14, 46, 48, 50 is operational.

EI process 14, 46, 48, 50 may monitor 100 the actions taken by the user (e.g., user 32, 34, 36, 38) of website 150. For example, EI process 14, 46, 48, 50 may monitor 100 the content being reviewed (i.e. rendered on screen). Additionally/alternatively, the EI process 14, 46, 48, 50 may monitor 100 the various icons/links selected by the user via screen pointer 158 (which is controllable via a pointing device, not shown). In this particular example, the user (e.g., user 32, 34, 36, 38) is reading a review 160 of “GN Netcom's Dual Connectivity Headset”. EI process 14, 46, 48, 50 may associate 102 these actions (e.g., reading the review) taken by the user with one or more experts skilled in a technological area associated with these actions. Continuing with the above stated example, as the user is reading a review 160 of a dual connectivity headset, the experts associated 102 with this action may be skilled in “telecommunications”.

A datastore (not shown) may be maintained locally (e.g., on client computers 16, 18, personal digital assistant 20, or data-enabled cellular telephone 22 by EI process 14, 46, 48, 50, respectively) or remotely (e.g., on server computer 12 by EI process 10) that associates one or more of a plurality of experts with one or more of a plurality of technological areas. Continuing with the above-stated example, if the technological area associated with review 160 is “telecommunications”, when associating 102 one or more experts with the actions taken by the user (e.g., reading a review 160 concerning a “telecommunications” product), EI process 14, 46, 48, 50 and/or EI process 10 may query the datastore (not shown) to identify the available experts skilled in “telecommunications”.

Examples of the datastore may include, but are not limited to, an Oracle™ database, an IBM DB2™ database, a Sybase™ database, a Computer Associate™ database, and a Microsoft Access™ database. When defining the available experts, EI process 14, 46, 48, 50 and/or EI process 10 may only identify those experts that are currently available for consultation. For example, those experts that are not currently working or are currently consulting with other users may not be identified.

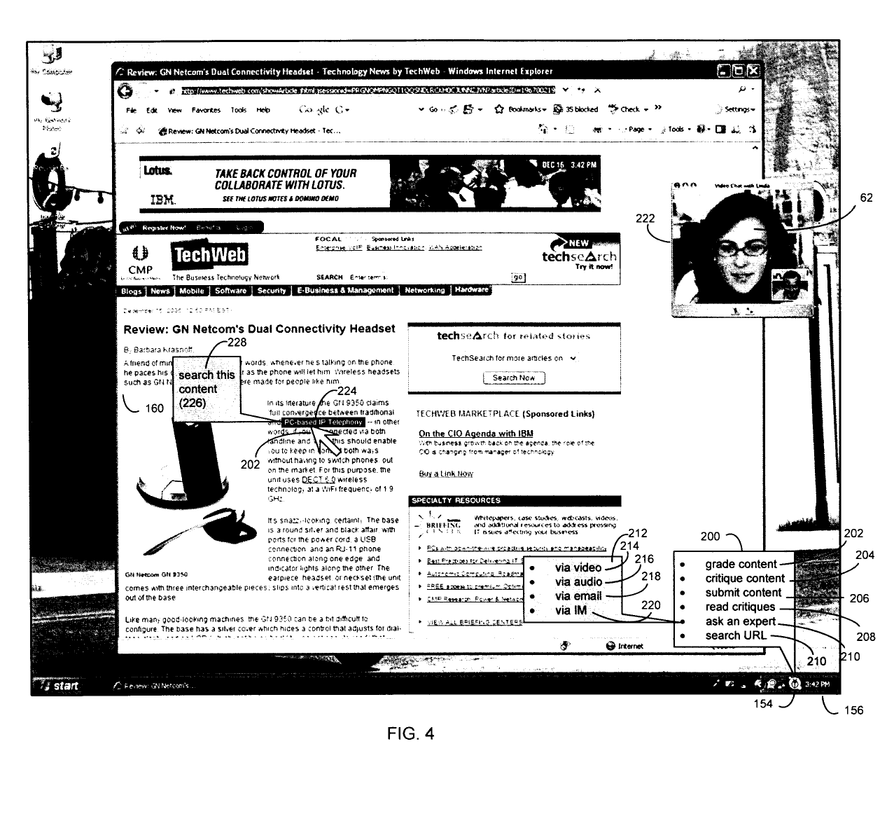

Referring also to FIG. 4, assume that the user (e.g., user 32) is researching dual connectivity headsets in anticipation of purchasing several hundred headsets for a company for which they perform IT-related services. Further, assume that review 160 is a positive review and it appears (at least on a cursory level) that “GN Netcom's Dual Connectivity Headset” may provide the level of service and functionality that the user needs. However, the user may wish to obtain some enhanced information concerning “GN Netcom's Dual Connectivity Headset”. Accordingly, the user may select (with screen pointer 158) icon 154 rendered within system tray 156. In response to this selection, EI process 14, 46, 48, 50 and/or EI process 10 may render a first menu 200 that allows the user to obtain the desired enhanced information. Alternatively, menu 200 may be automatically rendered (by EI process 14, 46, 48, 50 and/or EI process 10) if such enhanced information is available, thus eliminating the need for the user to select icon 154 with screen pointer 158. Once menu 200 is rendered, the user may be presented with a plurality of options. For example, menu 200 is shown to include a “grade content” item 202, a “critique content” item 204, a “submit content” item 206, a “read critiques” item 208, and an “ask an expert” item 210.

By selecting “grade content” item 202 (with e.g., screen pointer 158) within menu 200, the user (e.g., user 32) may assign 104 a grade to the content item (e.g., review 160) being reviewed by the user. If the user selects “grade content” item 202, a content grading window (not shown) may be rendered by EI process 14, 46, 48, 50 and/or EI process 10 that allows the user to assign 104 a grade to the content (e.g., review 160). Examples of the grades assignable to the content may include, but are not limited to, a numeric 1.0-10.0 grade and a letter-based A, B, C, D, F grade. Once submitted, the grade assigned 104 to the content may be stored on the local and/or remote datastore discussed above.

By selecting “critique content” item 204 (with e.g., screen pointer 158) within menu 200, the user (e.g., user 32) may critique 106 the content item (e.g., review 160) being reviewed by the user. If the user selects “critique content” item 204, a critiquing window (not shown) may be rendered by EI process 14, 46, 48, 50 and/or EI process 10 that allows the user to assign a grade to the content (e.g., review 160). When critiquing a content item, the level of structure of the critique may be varied depending on the manner in which EI process 14, 46, 48, 50 and/or EI process 10 are implemented. For example, a structured critiquing window (not shown) may be rendered that only allows the user to answer a series of multiple-choice questions, resulting in (essentially) a more-detailed grading system for the content being reviewed. Alternatively, a quasi-structured critiquing window (not shown) may be rendered that allows the user to provide answers to both structured multiple-choice questions and open-ended essay type questions. Further still, a free form critiquing window (not shown) may be rendered that allows the user to generate a free-form critique. Once submitted, the critiques provided for the content may be stored on the local and/or remote datastore discussed above.

By selecting “read critiques” item 208 (with e.g., screen pointer 158) within menu 200, the user (e.g., user 32) may review third-party critiques of the content (e.g., review 160) currently being reviewed by the user. As discussed above, “critique content” item 204 allows users to submit critiques of the content (e.g., review 160) being reviewed by the user. Further and as discussed above, these critiques may be stored on the local and/or remote datastore discussed above, Accordingly, when the user selects “read critiques” item 208 from menu 200, EI process 14, 46, 48, 50 and/or EI process 10 may execute a query of the datastore (discussed above) and EI process 14, 46, 48, 50 and/or EI process 10 may render a result set window (not shown) that identifies one or more critiques submitted concerning the content currently being reviewed (e.g., review 160). The user may then review one or more of the critiques included in this result set to determine e.g., the level of trust/weight that the user should apply to this content.

By selecting “ask an expert” item 210 (with e.g., screen pointer 158) within menu 200, EI process 14, 46, 48, 50 and/or EI process 10 may facilitate 108 communication between the user (e.g., user 32) and at least one of the experts skilled in the relevant technological area (e.g., “telecommunications”). Continuing with the above-stated example, assume that review 160 is a positive review and it appears (at least on a cursory level) that “GN Netcom's Dual Connectivity Headset” may provide the level of service and functionality that the user needs. Further, assume that the user reviewed several critiques of the content (e.g., review 160) and found that other users generally agreed with the review and found that the author of review 160 tended to provide fair and unbiased reviews. At this point, the user may be interested in getting a second opinion from an expert skilled in this technological area.

Accordingly, EI process 14, 46, 48, 50 and/or EI process 10 may facilitate 108 communication with one or more experts through a plurality of menus (e.g., menu 200 and submenu 212). Once the user (e.g., user 32) selects “ask an expert” item 210, submenu 212 may be rendered that allows the user to define the type of communication channel established between the user and the expert. For example, submenu 212 is shown to include four items, namely “via video” item 214, “via audio” item 216, “via email” item 218, and “via IM” (i.e., instant messenger) item 220. Selecting any one of these items may have a cost associated with it. For example, a user may be charged $5.00 per minute for a video conference, $4.00 per minute for an audio conference, $3.00 per minute for an IM “chat”, and $5.00 per email for email exchanges. Alternatively, any and all of these items 214, 216, 218, 220 may be billed on a per event flat fee.

By selecting “via video” item 214 (with e.g., screen pointer 158) within submenu 212, EI process 14, 46, 48, 50 and/or EI process 10 may establish 110 communication between the expert (e.g., expert 62) and the user (e.g., user 32) and a video conference may be initiated 112. A video conference window 222 may be rendered by EI process 14, 46, 48, 50 and/or EI process 10, thus allowing for audio/video communication between the expert (e.g., expert 62) and the user (e.g., user 32). In order to initiate 112 the video conference, client computers 16, 18, personal digital assistant 20, and/or data-enabled cellular telephone 22 may be required to include various hardware/software components (e.g., a camera capable of streaming video across a network and a microphone capable of streaming audio across a network). Once video conference window 222 is rendered, the user and expert 62 may discuss “GN Netcomm's Dual Connectivity Headset”, other dual connectivity headsets, or telecommunications technology in general since (as discussed above) EI process 14, 46, 48, 50 and/or EI process 10 determined that expert 62 is skilled in the technological area of “telecommunications” prior to establishing 110 communication between the user and expert 62.

By selecting “via audio” item 216 (with e.g., screen pointer 158) within submenu 212, EI process 14, 46, 48, 50 and/or EI process 10 may establish 110 communication between the expert (e.g., expert 62) and the user (e.g., user 32) and an audio conference may be initiated 114. An audio conference window (not shown) may be rendered by EI process 14, 46, 48, 50 and/or EI process 10, thus allowing for audio communication between the expert and the user. In order to initiate 114 the audio conference, client computers 16, 18, personal digital assistant 20, and/or data-enabled cellular telephone 22 may be required to include various hardware/software components (e.g., a microphone capable of streaming audio across a network). Once the audio conference is initiated 114, the user and expert 62 may discuss “GN Netcomm's Dual Connectivity Headset”, other dual connectivity headsets, or telecommunications technology in general since (as discussed above) EI process 14, 46, 48, 50 and/or EI process 10 determined that expert 62 is skilled in the technological area of “telecommunications” prior to establishing 110 communication between the user and expert 62.

By selecting “via email” item 218 (with e.g., screen pointer 158) within submenu 212, EI process 14, 46, 48, 50 and/or EI process 10 may establish 110 communication between the expert (e.g., expert 62) and the user (e.g., user 32) and an email conference may be initiated 116. An email composition window (not shown) may be rendered by EI process 14, 46, 48, 50 and/or EI process 10 that allows the user to compose an email to the expert that e.g., defines the enhanced information desired. Alternatively, the email composition window (not shown) may be rendered by a third-party software application, examples of which may include, but are not limited to, Microsoft Outlook™ and Lotus Notes™, Once the email conference is initiated 116, the user and expert 62 may discuss “GN Netcomm's Dual Connectivity Headset”, other dual connectivity headsets, or telecommunications technology in general since (as discussed above) EI process 14, 46, 48, 50 and/or EI process 10 determined that expert 62 is skilled in the technological area of “telecommunications” prior to establishing 110 communication between the user and expert 62.

By selecting “via IM” item 220 (with e.g., screen pointer 158) within submenu 212, EI process 14, 46, 48, 50 and/or EI process 10 may establish 110 communication between the expert (e.g., expert 62) and the user (e.g., user 32) and an IM conference may be initiated 118. A IM chat window (not shown) may be rendered by EI process 14, 46, 48, 50 and/or EI process 10, thus allowing for instant message communication between the expert and the user. In order to initiate 118 the IM conference, client computers 16, 18, personal digital assistant 20, and/or data-enabled cellular telephone 22 may be required to include various hardware/software components (e.g., an instant messaging program such a Windows Messenger™ and Yahoo Messenger™). Once the IM conference is initiated 118, the user and expert 62 may discuss “GN Netcomm's Dual Connectivity Headset”, other dual connectivity headsets, or telecommunications technology in general since (as discussed above) EI process 14, 46, 48, 50 and/or EI process 10 determined that expert 62 is skilled in the technological area of “telecommunications” prior to establishing 110 communication between the user and expert 62.

When communication is established 110 between the expert (e.g., expert 62) and the user (e.g., user 32), a copy (or a portion thereof) 64 of the content being reviewed by the user may be transferred 120 to the expert (e.g., expert 62) to which communication is established 110, thus allowing the expert to e.g., review the content during the discussion with the user. Further, upon the communication session between the user and the expert being terminated (e.g., the closing of video conference window 222, the closing of the audio conference window (not shown), the closing of the IM chat window (not shown), or the transmission of a final email between the expert and the user, the copy (or portion thereof) 64 of the content transferred 120 to the expert may be deleted from expert's computer 66.

The user (e.g., user 32) of EI process 14, 46, 48, 50 and/or EI process 10 may author and submit content for other users to review. For example, if the user wishes to upload content (and assuming that the user is authorized to upload content), the user may select “submit content” item 206 from menu 200. EI process 14, 46, 48, 50 and/or EI process 10 may render an upload window (not shown) that e.g., allows a user to locate the content to be uploaded and effectuate the copying of the content from e.g., the user's computer (e.g., computer 16) to e.g., server computer 12.

While EI process 14, 46, 48, 50 and/or EI process 10 are described above as obtaining enhanced information for a piece of content (e.g., review 16) being reviewed by the user (e.g., user 32), other configurations are possible and are considered to be within the scope of this disclosure. For example, EI process 14, 46, 48, 50 and/or EI process 10 may be configured to allow a user to identify 124 a portion 224 of the content being reviewed. This identification process 124 may occur by allowing the user (e.g., user 32) to highlight a portion 224 of the content being reviewed (e.g., review 160). Upon the user e.g., “right clicking” on highlighted portion, a search menu 226 may be rendered by EI process 14, 46, 48, 50 and/or EI process 10 that allows the user to obtain enhanced information concerning the highlighted portion 224 of the content. For example, the user (e.g., user 32) may identify 124 a portion 224 of the content (e.g., review 160) being reviewed by the user, namely “PC-based IP Telephony”. Once this identification 124 is completed, the user may “right click” on selected portion 224 and search menu 226 may be generated. In the particular embodiment, search menu 226 is shown to include one item, namely “search this content” item 228.

By selecting “search this content” item 228 (with e.g., screen pointer 158) within search menu 226, EI process 14, 46, 48, 50 and/or EI process 10 may associate 126 the selected portion 224 of the content with one or more experts skilled in a technological area associated with the selected portion of the content. Continuing with the above stated example, as the user selected “PC-based IP Telephony”, the experts associated 126 with this action may be skilled in “Telecommunications”.

As discussed above, a datastore (not shown) may be maintained locally (e.g., on client computers 16, 18, personal digital assistant 20, or data-enabled cellular telephone 22 by EI process 14, 46, 48, 50) or remotely (e.g., on server computer 12 by EI process 10) that associates one or more of a plurality of experts with one or more of a plurality of technological areas. Continuing with the above-stated example, if the technological area associated with selected portion 224 is “telecommunications”, when associating 126 one or more experts with selected portion 224, EI process 14, 46, 48, 50 and/or EI process 10 may query the datastore to identify the available experts skilled in “telecommunications”.

In addition to allowing the user to obtain enhanced information concerning e.g., all or a portion of the content being reviewed by the user, other configurations are possible and are considered to be within the scope of this disclosure. For example, by selecting “search URL” item 230 from menu 200, EI process 14, 46, 48, 50 and/or EI process 10 may obtain enhanced information concerning the identified uniform resource locator (i.e., URL). For example, EI process 14, 46, 48, 50 and/or EI process 10 may allow the user (e.g., user 32) to identify 128 the URL to be searched by selecting “search URL” item 128. In this particular example, the URL to be searched is:
http.//www.techweb.com/showArticle.jhtml;jsessionid=PRGNQMPNGQT1QQSNDLR CKH0CJUNN2JVN?articleID=196700219

Once identified 128, a query may be executed 130 on the datastore (not shown) based, at least in part, upon the identified URL. As discussed above, the datastore (not shown) may be maintained locally (e.g., on client computers 16, 18, personal digital assistant 20, or data-enabled cellular telephone 22 by EI process 14, 46, 48, 50) or remotely (e.g., on server computer 12 by EI process 10). In addition to associating one or more of a plurality of experts with one or more of a plurality of technological areas, this datastore (not shown) may allow searching for enhanced information based on an identified URL. For example, the datastore (not shown) may identify a plurality of articles that are related to/concern the identified URL. Additionally/alternatively, the datastore may associate the identified URL with a specific technological area. Therefore, if the technological area associated with the identified URL is “telecommunications”, EI process 14, 46, 48, 50 and/or EI process 10 may query 130 the datastore (not shown) to identify enhanced information that is available concerning the identified URL. As discussed, this enhanced information may be identified by associating the identified URL with specific technological area (e.g., “telecommunications”) and then querying 130 the datastore (not shown) to identify enhanced information concerning e.g., “telecommunications”. EI process 14, 46, 48, 50 and/or EI process 10 may present 132 this enhanced information to the user. For example, an information menu (not shown) may be rendered that itemizes the enhanced information available concerning the identified URL.

Additionally, in addition to monitoring 100 the actions taken by the user, EI process 14, 46, 48, 50 and/or EI process 10 may record 134 these actions to define consumer information. Examples of the actions recorded may include, but are not limited to, the particular articles/reviews that were read, the particular URLs visited, the amount of time spent reviewing each article/review read, the amount of time spent visiting each URL, and the ratings assigned by the user. EI process 14, 46, 48, 50 and/or EI process 10 may then extract 136 marketing information from this recorded consumer information. For example, EI process 14, 46, 48, 50 and/or EI process 10 may identify: popular versus unpopular URLs; popular versus unpopular articles/reviews; and popular versus unpopular technological areas, for example.

EI process 14, 46, 48, 50 and/or EI process 10 may further identify the likely nature and source of the content being reviewed by the user (e.g., user 32). This identification may be facilitated by comparing the content being reviewed to one or more content templates and/or by querying a content provider database maintained on the above-described datastore (not shown).

Additionally, EI process 14, 46, 48, 50 and/or EI process 10 may store enhanced information concerning the content being reviewed by the user (e.g., user 32). For example, EI process 14, 46, 48, 50 and/or EI process 10 may store statistical information regarding e.g., what particular content was rendered on the viewing screen of the user. This information may be sorted based upon, for example, the content source (e.g., by URL), the content type (e.g., periodical, blog, resource website, etc.), the content topic (e.g., printers, network servers, VoIP, etc.); and the total content review time (e.g., by person, by department, etc.), for example.

As discussed above, EI process 14, 46, 48, 50 and/or EI process 10 may allow a user (e.g., user 32) to grade content 104 and critique content 106. Further, EI process 14, 46, 48, 50 and/or EI process 10 may solicit content from the user and may solicit reviews/critiques of the content from the user. The content and/or reviews/critiques received from the user may be stored on the above-described datastore (not shown) and may be made available to other users

EI process 14, 46, 48, 50 and/or EI process 10 may facilitate the automatic summarization of the content (or a portion thereof). The summarization of the content may be facilitated via a third party application (not shown) that is configured to interact with EI process 14, 46, 48, 50 and/or EI process 10, examples of which may include but are not limited to Copernic™, and Pertinence Summarizer™.

EI process 14, 46, 48, 50 and/or EI process 10 may allow the user (e.g., user 32) to obtain additional/supplemental content that is related to the content being reviewed by the user. For example, if the user is reading an article about printers, EI process 14, 46, 48, 50 and/or EI process 10 may offer to obtain additional ” printer” related content. EI process 14, 46, 48, 50 and/or EI process 10 may query the above-described datastore (not shown) to identify the related content. Further, EI process 14, 46, 48, 50 and/or EI process 10 may allow the user (e.g., user 32) to interact (as discussed above in greater detail) with experts concerning this related content by e.g., initiating 112 a video conference, initiating 114 an audio conference, initiating 116 an email conference, and initiating an IM conference, for example.

A number of implementations have been described. Nevertheless, it will be understood that various modifications may be made. Accordingly, other implementations are within the scope of the following claims.

What is claimed is:

1. A method comprising:
monitoring one or more actions taken by a user of a website;
associating at least one of the one or more actions with one or more experts skilled in a technological area associated with the one or more actions; and
facilitating communication between the user and at least one of the one or more experts skilled in the technological area.

2. The method of claim 1 wherein the at least one of the one or more actions includes the user reviewing a content item.

3. The method of claim 2 wherein monitoring one or more actions taken by a user of a website includes:
identifying one or more specific portions of the content item being reviewed by the user.

4. The method of claim 3 wherein associating at least one of the one or more actions includes:
associating at least one of the specific portions of the content item being reviewed by the user with one or more experts skilled in a technological area associated with the at least one of the specific portions of the content item being reviewed by the user.

5. The method of claim 1 further comprising:
establishing communication between the user and the at least one of the one or more experts skilled in the technological area; and
transferring a copy of at least a portion of the content being reviewed by the user to the at least one of the one or more experts skilled in the technological area.

6. The method of claim 5 further comprising:
deleting the copy of the content transferred to the at least one of the one or more experts skilled in the technological area once communication between the user and the at least one of the one or more experts skilled in the technological area is completed.

7. The method of claim 5 wherein establishing communication includes one or more of:
initiating a video conference between the user and at least one of the one or more experts skilled in the technological area;
initiating an audio conference between the user and at least one of the one or more experts skilled in the technological area; and
initiating an email conference between the user and at least one of the one or more experts skilled in the technological area.

8. The method of claim 1 further comprising:
assigning a grade to a content item being reviewed by the user.

9. The method of claim 1 further comprising:
critiquing a content item being reviewed by the user.

10. The method of claim 1 wherein the one or more actions taken by the user includes browsing the website.

11. The method of claim 10 further comprising:
identifying a URL associated with the website; and
executing a query on a datastore based, at least in part, upon the URL associated with the website to identify available information that is associated with the website.

12. The method of claim 11 further comprising:
presenting at least a portion of the available information to the user.

13. The method of claim 1 further comprising:
recording the one or more actions taken by the user to define consumer information; and
extracting marketing information from the consumer information.

14. A computer program product residing on a computer readable medium having a plurality of instructions stored thereon which, when executed by a processor, cause the processor to perform operations comprising:
monitoring one or more actions taken by a user of a website;
associating at least one of the one or more actions with one or more experts skilled in a technological area associated with the one or more actions; and
facilitating communication between the user and at least one of the one or more experts skilled in the technological area.

15. The computer program product of claim 14 wherein the at least one of the one or more actions includes the user reviewing a content item.

16. The computer program product of claim 15 wherein the instructions for monitoring one or more actions taken by a user of a website include instructions for:
identifying one or more specific portions of the content item being reviewed by the user.

17. The computer program product of claim 16 wherein the instructions for associating at least one of the one or more actions include instructions for:
associating at least one of the specific portions of the content item being reviewed by the user with one or more experts skilled in a technological area associated with the at least one of the specific portions of the content item being reviewed by the user.

18. The computer program product of claim 14 further comprising instructions for:
establishing communication between the user and the at least one of the one or more experts skilled in the technological area; and
transferring a copy of at least a portion of the content being reviewed by the user to the at least one of the one or more experts skilled in the technological area.

19. The computer program product of claim 18 further comprising instructions for:
deleting the copy of the content transferred to the at least one of the one or more experts skilled in the technological area once communication between the user and the at least one of the one or more experts skilled in the technological area is completed.

20. The computer program product of claim 18 wherein the instructions for establishing communication include instructions for one or more of:
initiating a video conference between the user and at least one of the one or more experts skilled in the technological area;
initiating an audio conference between the user and at least one of the one or more experts skilled in the technological area; and
initiating an email conference between the user and at least one of the one or more experts skilled in the technological area.

21. The computer program product of claim 14 further comprising instructions for:
assigning a grade to a content item being reviewed by the user.

22. The computer program product of claim 14 further comprising instructions for:
critiquing a content item being reviewed by the user.

23. The computer program product of claim 14 wherein the one or more actions taken by the user includes browsing the website.

24. The computer program product of claim 23 further comprising instructions for:
identifying a URL associated with the website; and
executing a query on a datastore based, at least in part, upon the URL associated with the website to identify available information that is associated with the website.

25. The computer program product of claim 24 further comprising instructions for:
presenting at least a portion of the available information to the user.

26. The computer program product of claim 14 further comprising instructions for:
recording the one or more actions taken by the user to define consumer information; and
extracting marketing information from the consumer information.
